(19) United States
(12) Patent Application Publication
(10) Pub. No.: US 2014/0110501 A1
(43) Pub. Date: Apr. 24, 2014

(54) ROTARY DISTRIBUTOR HEAD FOR A SPRINKLER

(71) Applicants: Jerry D. Lawyer, Clermont, FL (US); Justin Pekarek, Minneola, FL (US); Jay Huberty, Orlando, FL (US)

(72) Inventors: Jerry D. Lawyer, Clermont, FL (US); Justin Pekarek, Minneola, FL (US); Jay Huberty, Orlando, FL (US)

(21) Appl. No.: 13/657,933

(22) Filed: Oct. 23, 2012

(51) Int. Cl. B05B 3/04

(52) U.S. Cl. 239/222.17

(57) ABSTRACT

A rotary distributor head for a sprinkler is disclosed. In a particular embodiment, the head includes a stack of deflector pads axially aligned. The head also includes a plurality of distribution channels radially disposed on at least one deflector pad that are configured to distribute a stream of water over a surrounding area. A plurality of spiral grooves is disposed on at least one deflector pad that are configured to cause the head to rotate when the water is flowing through the grooves. In addition, the head includes an orifice on each upstream deflector pad configured to pass a portion of the stream of water through to an adjacent downstream deflector pad. The head controls a rotational speed while increasing the uniform wetted footprint of instantaneous impact under a range of operating pressures and flow rates.

### I. FIELD

The present invention relates in general to a rotary distributor head for a sprinkler.

### II. DESCRIPTION OF RELATED ART

In sprinkler irrigation systems, water is received under pressure and is introduced into a main water supply pipe which is connected with one or more distributing pipes forming a fluid conduit. The irrigation system typically includes a plurality of discharge irrigation sprinkler heads to distribute water uniformly over a surrounding area. The sprinkler heads may be of the rotatably driven deflector type where a water stream is directed against the deflector, which drives the deflector using a series of channels that turn outwardly. In operation, the water stream impinges on the surface of the deflector and fills the channels to rotatably drive the deflector. As a consequence, water is thrown radially outward and swept out over the surrounding area.

A shortcoming of the rotatably driven deflector type head is the inability to control the rotational speed of the deflector. High rotational speeds result in less effective water distribution patterns and excessive sprinkler wear. Prior attempts to control the rotational speed include a fluid brake device which generally is a rotor element attached to the deflector and placed in a viscous fluid. The viscous fluid applies a drag on the rotor element to reduce the rotational speed of the deflector. However, the fluid brake devices do not consistently control the speed and vary with changes in water pressures and flow rates, which is prevalent in irrigations systems.

Another attempt to control the rotational speed is the use of braking channels on the deflector. One example is U.S. Pat. No. 7,240,860 to Griend, which describes a rotor plate that includes brake channels to slow the rotation of the deflector. A disadvantage of this design of including brake channels and distribution channels on the same deflector, is that the brake channels are curved opposite of the channels intended to distribute the water radially. Thus, each rotation of the deflector distributes less water, less uniformly, than a deflector with all channels on the deflector working together to distribute water.

Accordingly, what is needed in the art is a rotary distributor head for a sprinkler that controls the rotational speed while increasing the uniform wetted footprint of instantaneous impact under a range of operating pressures and flow rates.

However, in view of the prior art at the time the present invention was made, it was not obvious to those of ordinary skill in the pertinent art how the identified needs could be fulfilled.

### III. SUMMARY

In a particular embodiment, a rotary distributor head is disclosed. The head includes a first deflector pad, a plurality of distribution channels radially disposed on the first deflector pad configured to distribute a stream of water, and a second deflector pad axially aligned downstream of the first deflector pad. In addition, the head includes an orifice disposed on the first deflector pad configured to pass a portion of the stream of water through the first deflector pad to the second deflector pad. A plurality of grooves is radially disposed on the second deflector pad configured to cause the head to rotate when the water is flowing through the grooves.

In another particular embodiment, the head includes a stack of three or more deflector pads axially aligned, a plurality of distribution channels radially disposed on at least one deflector pad configured to distribute a stream of water, a plurality of spiral grooves disposed on at least one deflector pad configured to cause the head to rotate when the water is flowing through the grooves, and an orifice on each upstream deflector pad configured to pass a portion of the stream of water through to an adjacent downstream deflector pad.

One particular advantage provided by the embodiments of the rotary distributor head for a sprinkler is to control the rotational speed of the deflector pad while increasing an area of instantaneous impact and uniformity under a range of operating water pressures and flow rates.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is an elevational view of a sprinkler with a particular embodiment of a rotary distributor head;

FIG. 2 is a sectional view of the sprinkler of FIG. 1;

FIG. 3 is an elevational view of the rotary distributor head of FIG. 1;

FIG. 4 is an exploded top perspective view of the rotary distributor head of FIG. 3;

FIG. 5 is an exploded view bottom perspective view of the rotary distributor head of FIG. 3;

FIG. 6 is a top view of a deflector pad showing a plurality of grooves disposed on the top surface;

FIG. 7 is a top perspective view of another particular embodiment of a rotary distributor head; and

FIG. 8 is an elevational view of the rotary distributor head of FIG. 7.

### V. DETAILED DESCRIPTION

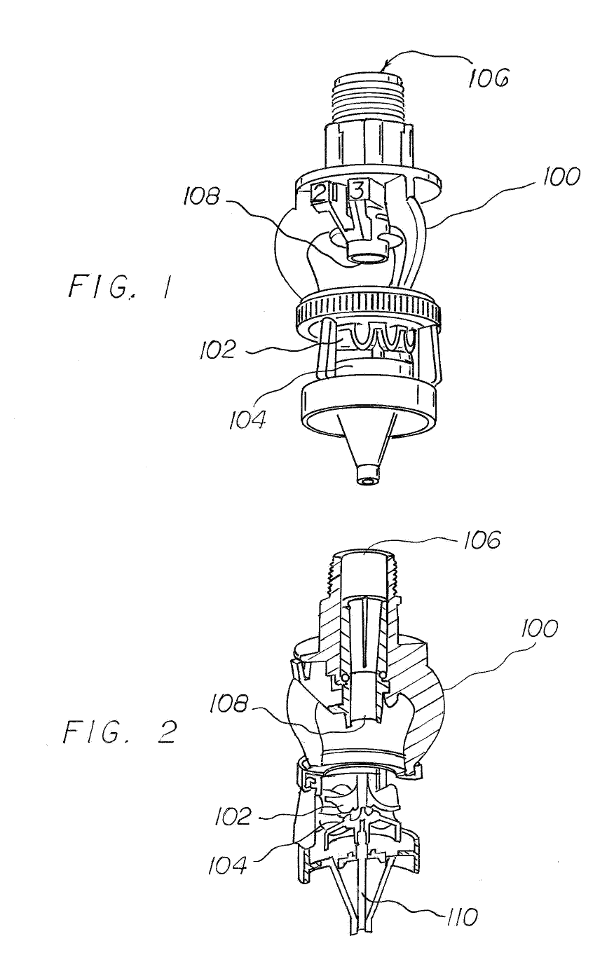

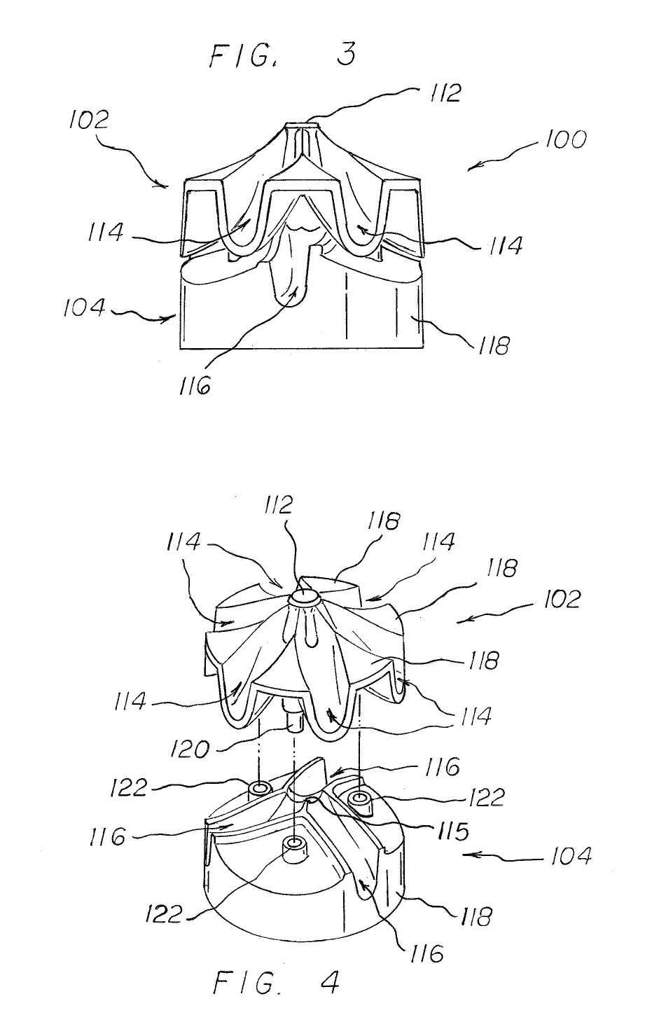

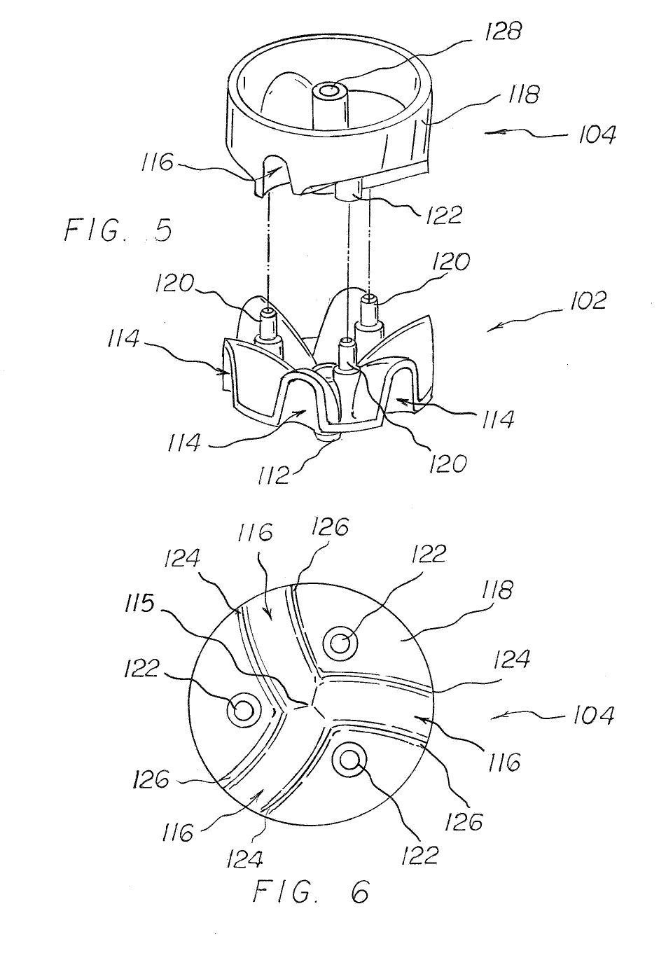

Referring now to FIGS. 1 and 2, a sprinkler is illustrated and generally designated 100. The sprinkler 100 includes an inlet housing 106 and a nozzle 108. The sprinkler 100 is adapted for use with an irrigation system such that the inlet housing 106 may have external threads. The external threading allows the sprinkler 100 to be easily threadedly attached into the water line of the irrigation system. The sprinkler 100 is a rotating stream type sprinkler for sweeping small streams of irrigation water in a radially outward direction to the surrounding area. In operation, water under pressure is delivered to the sprinkler 100 to produce a water stream or jet that impinges on the head of the sprinkler 100 described below.

A rotary distributor head of the sprinkler 100 includes a first deflector pad 102 and a second deflector pad 104 that are located downstream of the nozzle 108. The deflector pads 102, 104 are axially aligned to the nozzle 108 where a stream of water exits the nozzle 108 and impacts a top surface of the first deflector pad 102. The deflector pads 102, 104 (collectively, the “head”) are stacked together and rotate about a central shaft 110 or axis. The head provides for a relatively constant rotational speed through a range of flow rates at a given operating pressure.

In this particular embodiment, the head includes two deflector pads 102, 104. However, additional deflector pads may be used and stacked together as desired. Accordingly, the head has the ability to be adjusted to address each particular application to achieve the desired irrigation specifications by using different configurations and combinations of deflector pads with different characteristics. The first deflector pad 102 is configured to divide a water steam or jet received from the nozzle 108 into a plurality of water streams. As a portion of the water stream impinges the second deflector pad 104 causing rotation of the head, the plurality of water streams are swept over the surrounding area.

Turning now to FIG. 3, the first deflector pad 102 includes a plurality of channels 114, which redirect the stream of water radially outward from the sprinkler 100. The channels 114 may be neutral with respect to the rotation of the head and are primarily used to increase the range of the sprinkler 100. In addition, the channels 114 on the first deflector pad 102 are spaced to provide a uniform pattern over the surrounding area. The channels 114 are suitably tapered to extend radially outward and axially away from the center of the deflector pad 102.

In accordance with further aspects of the head, a portion of the stream of water passes through an orifice 112 centrally disposed on the first deflector pad 102 to the downstream second deflector pad 104. A top surface of the first deflector pad 102 may be sloped outwards from the orifice 112 forming a truncated conical shape that is tapered to direct the water into the channels 114. A center divider 115 of the second deflector pad 104 divides the remaining water and directs the water into a plurality of spiral grooves 116, which distributes the remaining water radially outward. The spiral grooves 116 may be formed into an annular base 118 of the second deflector pad 104.

The plurality of spiral grooves 116 are radially disposed on the second deflector pad 104 and are configured to cause the deflector pads 102, 104 to rotate together when the water is flowing through the grooves 116. The spiral grooves 116 of the second deflector pad 104 are shaped in such a way to cause water exiting them to have a varying trajectory to direct the water radially outward from a center axis to generate a desired torque on the second deflector pad 104. The trajectory of each channel 114 of the first deflector 102 may be neutral, or opposite, to the trajectory of the plurality of grooves 116 of the second deflector pad 104. Accordingly, the channels 114 may be used, if necessary, to slow the rotational speed of the head. Thus, a combination of curvature of the channels 114 and the spiral grooves 116 may be used to produce a desired rotational speed under numerous different operating pressures, flow rates and conditions.

For example, the curvature of the channels 114 may be used as a braking mechanism to slow down the rotation of the head by having the curvature of the channels 114 in an opposing direction to that of the spiral grooves 116 of the downstream second deflector pad 104. Thus, the torque created by the spiral grooves 116 to rotate the head in a first direction, is offset in part by the channels 114 producing a torque in an opposing direction.

In addition, the size of the orifice 112 is such that the volume of water impinging on the second deflector pad 104 may eliminate the need for any braking altogether. In operation, the orifice 112 limits the amount of water impinging the second deflector pad 104 to maintain the rotation at a relatively constant speed over a range of flow rates at a given operating pressure. This ability to control the amount of water impinging the second deflector pad 104 and spiral grooves 116 that are driving the rotation of the head represents an advance over existing rotor plate designs that include braking channels and drive channels on the same rotor plate. In addition, a larger surface area is available to place more channels on the deflector pads to allow for greater control and freedom of where the water is distributed over a given area.

A connector is used to stack together the first deflector pad 102 and the second deflector pad 104. In a particular embodiment, the connector includes three struts 120 that extend downstream from an underside of the first deflector pad 102. Receptacles 122 are disposed on a top surface of the second deflector pad 104 that are adapted to slidingly engage and receive the respective struts 120 to secure the first pad 102 to the second pad 104 using a suitable snap-fit connection or the like. In this particular embodiment, the pads 102, 104 are separate elements, however, in another embodiment the pads 102, 104 are constructed as a single unit to form the head. One advantage of using a snap-fit connector as described herein is that the deflector pads are interchangeable.

As explained above, the rotary distributor head includes at least one deflector pad 102 configured to distribute a stream of water. A plurality of spiral grooves 116 disposed on the downstream second deflector pad 104 is configured to cause the head to rotate when the water is flowing through the grooves 116, and an orifice 112 on each upstream deflector pad 102 is configured to pass a portion of the stream of water through to the adjacent downstream second deflector pad 104. The plurality of distribution channels 114 is configured to distribute the water to a uniform area of instantaneous impact. In such an arrangement, the distribution channels 114 may have a neutral trajectory from a center to a periphery of a respective deflector pad 102. The deflector pads are interchangeable to adjust the range of the sprinkler 100 or the rotational speed of the head by using deflector pads with a different configuration of grooves, a size of the orifice, or any combination thereof. Further, the spiral grooves 116 may have one or more different curvatures to cause water exiting them to have trajectories that do not oppose one another.

The distribution channels 114 may be uniform on the deflector pad 102. The cross section areas of the distribution channels 114 may increase along their lengths to the periphery of the deflector pads 102. In addition, the distribution channels 114 may be evenly spaced about the deflector pad.

As illustrated in FIG. 6, the plurality of spiral grooves 116 directs the water radially outward from a center axis to generate a desired torque on the stack of deflector pads 102, 104. The grooves 116 have a trajectory, or curvature, that changes from the center to the periphery of the respective deflector pad 104 to direct the water exiting each groove 116. The curvature of the grooves 116 is such that the water exits the grooves 116 at an angle relative to a radial through an axis of the deflector pad 104. The spiral grooves 116 are defined by a pair of opposing sidewalls 124, 126.

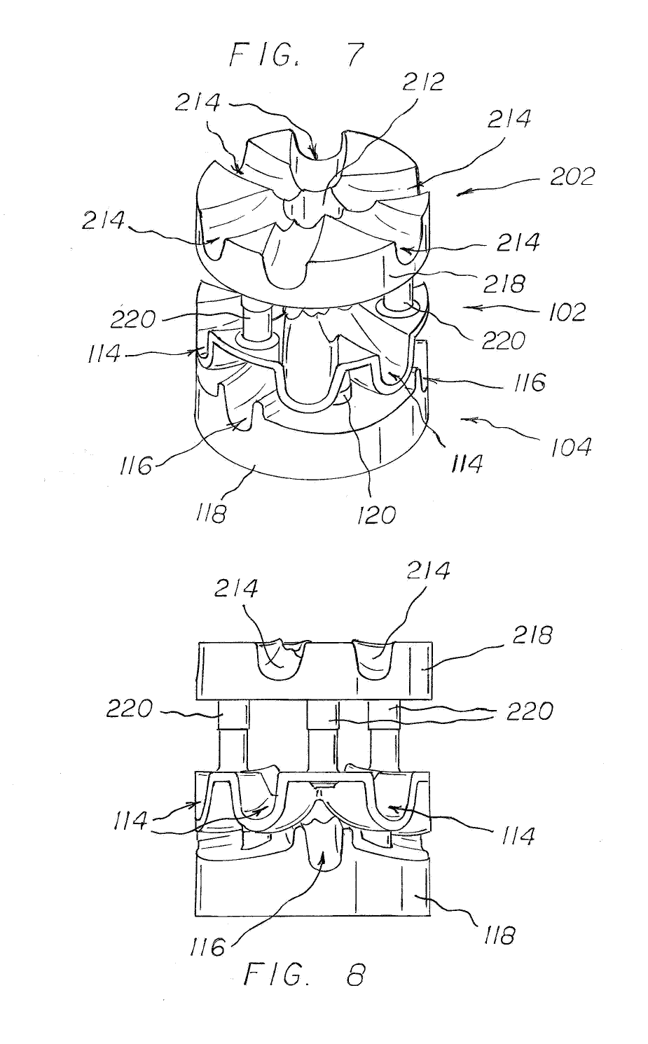

Another particular embodiment of the rotary distributor head is illustrated in FIGS. 7 and 8. In this particular embodiment, the head may include another upstream deflector pad 202, which is axially aligned to the downstream deflector pads 102, 104. An orifice 112, 212 on each upstream deflector pad 102, 202 is configured to pass a portion of the stream of water through to an adjacent downstream deflector pad 102, 104. Similar to the connector between the first deflector pad 102 and the second deflector pad 104 described above, there is an upstream connector between the top deflector pad 202 and the first deflector pad 102. The upstream connector may include three struts 220 that extend downstream from an underside of the top deflector pad 202. Receptacles are disposed on a top surface of the first deflector pad 102 that are adapted to slidingly engage and receive the respective struts 220 to secure the top deflector pad 202 to the first deflector pad 102 using a snap-fit connection, or similar means. In this particular embodiment, the pads 102, 104, 202 are separate elements, however, in another embodiment, the pads 102, 104, 202 may be constructed as a single unit to form the head. As explained above, an advantage of using connectors as described herein is that the deflector pads are interchangeable. Thus, making it easy to control the rotational speed while increasing the uniform wetted footprint of instantaneous impact for a sprinkler head under a range of operating pressures and flow rates.

The previous description of the disclosed embodiments is provided to enable any person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A rotary distributor head for a sprinkler, the head comprising:
a first deflector pad;
a plurality of distribution channels radially disposed on the first deflector pad configured to distribute a stream of water;
a second deflector pad axially aligned downstream of the first deflector pad;
an orifice disposed on the first deflector pad configured to pass a portion of the stream of water through the first deflector pad to the second deflector pad; and
a plurality of spiral grooves radially disposed on the second deflector pad configured to cause the head to rotate when the water is flowing through the grooves.

2. The rotary distributor head of claim 1, further comprising a connector to stack together the first deflector pad and the second deflector pad.

3. The rotary distributor head of claim 2, further comprising a shaft about which the head rotates.

4. The rotary distributor head of claim 3, wherein the first deflector pad is interchangeable to change a size of the orifice and adjust the portion of the stream of water to pass to the second deflector pad.

5. The rotary distributor head of claim 4, wherein the plurality of spiral grooves direct the water outward from a center axis to generate a desired torque on the second deflector pad.

6. The rotary distributor head of claim 5, wherein a trajectory of each channel of the first deflector pad is neutral or opposite to the trajectory of the plurality of spiral grooves of the second deflector pad.

7. The rotary distributor head of claim 6, the connector further comprising a plurality of struts that slidingly engage a lower surface of the first deflector pad to an upper surface of the second deflector pad.

8. The rotary distributor head of claim 7, the second pad further comprising a center divider configured to direct the water to each of the grooves.

9. The rotary distributor head of claim 8, wherein a periphery of the orifice is tapered to direct the water into the channels.

10. A rotary distributor head, the head comprising:
a stack of deflector pads axially aligned;
a plurality of distribution channels radially disposed on at least one deflector pad configured to distribute a stream of water;
a plurality of spiral grooves disposed on at least one deflector pad configured to cause the head to rotate when the water is flowing through the spiral grooves; and
an orifice on each upstream deflector pad configured to pass a portion of the stream of water through to an adjacent downstream deflector pad.

11. The rotary distributor head of claim 10, wherein the plurality of distribution channels are configured to distribute the water to a uniform area of instantaneous impact.

12. The rotary distributor head of claim 11, wherein the distribution channels have a neutral trajectory from a center to a periphery of a respective deflector pad.

13. The rotary distributor head of claim 12, wherein each spiral groove of the plurality of spiral grooves has the same trajectory.

14. The rotary distributor head of claim 13, wherein the deflector pads are interchangeable to adjust a rotation rate of the head by using deflector pads with a different configuration of grooves, a size of the orifice, or any combination thereof.

15. The rotary distributor head of claim 14, wherein each spiral groove is equidistantly spaced from an adjacent spiral groove about the respective deflector pad.

16. The rotary distributor head of claim 15, wherein the distribution channels are uniform on the deflector pad.

17. The rotary distributor head of claim 16, wherein a cross section area of each of the distribution channels increases along its length to the periphery of the respective deflector pad.

18. The rotary distributor head of claim 17, wherein the distribution channels are evenly spaced about the deflector pad.

19. The rotary distributor head of claim 18, wherein the plurality of grooves directs the water radially outward from a center axis to generate a desired torque on the stack of deflector pads.

20. A rotary distributor head, the head comprising
a stack of deflector pads axially aligned; and
an orifice on each upstream deflector pad configured to pass a portion of a stream of water through to an adjacent downstream deflector pad.
